(19) United States
(12) Patent Application Publication
(10) Pub. No.: US 2025/0197695 A1
(43) Pub. Date: Jun. 19, 2025

(54) COMPOSITION FOR FORMING CONDUCTIVE BONDING MATERIAL, CONDUCTIVE BONDING MATERIAL, DEVICE, AND MANUFACTURING METHOD OF CONDUCTIVE BONDING MATERIAL

(71) Applicant: FUJIFILM CORPORATION, Tokyo (JP)

(72) Inventor: Junji Kawaguchi, Shizuoka (JP)

(21) Appl. No.: 19/044,806

(22) Filed: Feb. 4, 2025

Related U.S. Application Data
(63) Continuation of application No. PCT/JP2023/030238, filed on Aug. 23, 2023.

(30) Foreign Application Priority Data
Sep. 30, 2022 (JP) 2022-157486

(51) Int. Cl. C09J 9/02; C08K 7/06; C08K 7/18; C09J 11/04; C09J 163/00

(52) U.S. Cl. CPC C09J 9/02; C09J 11/04; C09J 163/00; C08K 7/06; C08K 7/18; C08K 2201/001; C08K 2201/004; C08K 2201/005; C08K 2201/011

(57) ABSTRACT

An object of the present invention is to provide a composition for forming a conductive bonding material, which is capable of forming a conductive bonding material having high conductivity and high bonding strength, and a conductive bonding material, a device, and a manufacturing method of a conductive bonding material. The composition for forming a conductive bonding material of the present invention contains at least one conductive material selected from the group consisting of metal nanowires and a metal nanowire aggregate, and a solvent, in which a specific surface area of the conductive material per unit mass is 100 to 50,000 m²/kg, and a content of the conductive material is 30% by mass or more.

### CROSS-REFERENCE TO RELATED APPLICATIONS

This application is a Continuation of PCT International Application No. PCT/JP2023/030238 filed on Aug. 23, 2023, which claims priority under 35 U.S.C. § 119 (a) to Japanese Patent Application No. 2022-157486 filed on Sep. 30, 2022. The above applications are hereby expressly incorporated by reference, in their entirety, into the present application.

### BACKGROUND OF THE INVENTION

### 1. Field of the Invention

The present invention relates to a composition for forming a conductive bonding material, a conductive bonding material, a device, and a manufacturing method of a conductive bonding material.

### 2. Description of the Related Art

In recent years, various studies have been attempted on conductive materials using a metal nanowire or a metal nanopillar.

It is already known that porous alumina is used as a template in the production of nanomaterials as such a conductive material; and for example, JP2012-238592A discloses a method of obtaining a metal nanowire by subjecting an aluminum substrate to an anodization treatment, an aluminum substrate removal treatment, a penetration treatment, a metal filling treatment, and an anodized film removal treatment in this order ([0025] and [FIG. 1]), and also discloses a dispersion liquid containing a predetermined metal nanowire obtained by this method ([Claim 1]).

### SUMMARY OF THE INVENTION

As a result of studying the dispersion liquid containing the metal nanowire disclosed in JP2012-238592A, the present inventors have found that, in a case of using the dispersion liquid for forming a conductive bonding material (for example, a material used for bonding a semiconductor chip and a substrate), conductivity and a bonding strength may not be sufficient.

Therefore, an object of the present invention is to provide a composition for forming a conductive bonding material, which is capable of forming a conductive bonding material having high conductivity and high bonding strength, and a conductive bonding material, a device, and a manufacturing method of a conductive bonding material.

As a result of intensive studies to achieve the above-described objects, the present inventors have found that a conductive bonding material having high conductivity and high bonding strength can be formed of a composition for forming a conductive bonding material, in which a specific amount of a conductive material such as a metal nanowire, having a predetermined specific surface area, is formulated, and have completed the present invention.

In other words, it has been found that the above-described objects can be achieved by adopting the following configurations.
[1] A composition for forming a conductive bonding material, comprising:
at least one conductive material selected from the group consisting of metal nanowires and a metal nanowire aggregate; and
a solvent, in which a specific surface area of the conductive material per unit mass is 100 to 50,000 m²/kg, and
a content of the conductive material is 30% by mass or more.
[2] The composition for forming a conductive bonding material according to [1], further comprising:
conductive particles,
in which an average major diameter of the conductive particles in a minimum enclosing ellipsoid is 0.01 μm or more and 50 μm or less, and is 1 to 10 times an average minor diameter of the conductive particles in the minimum enclosing ellipsoid.
[3] The composition for forming a conductive bonding material according to [1] or [2], further comprising:
a resin material.
[4] The composition for forming a conductive bonding material according to any one of [1] to [3],
in which an arithmetic mean value of lengths of the metal nanowires is 0.3 to 300 μm.
[5] A conductive bonding material formed of the composition for forming a conductive bonding material according to any one of [1] to [4].
[6] A device comprising:
the conductive bonding material according to [5]; and
a member provided on at least one surface of the conductive bonding material,
in which the member is at least one selected from the group consisting of a semiconductor element, an electrode, and a wiring line.
[7] A manufacturing method of a conductive bonding material, which is for manufacturing a conductive bonding material, comprising:
a step of supplying the composition for forming a conductive bonding material according to any one of [1] to [4] onto a substrate.

According to the present invention, it is possible to provide a composition for forming a conductive bonding material, which is capable of forming a conductive bonding material having high conductivity and high bonding strength, and a conductive bonding material, a device, and a manufacturing method of a conductive bonding material.

### BRIEF DESCRIPTION OF THE DRAWINGS

FIG. 1A is a schematic cross-sectional view of a valve metal substrate before an anodization step in a procedure showing an example of a manufacturing method of metal nanowires according to an embodiment of the present invention.

FIG. 1B is a schematic cross-sectional view of a structure after the anodization step in the procedure showing the example of the manufacturing method of metal nanowires according to the embodiment of the present invention.

FIG. 1C is a schematic cross-sectional view of a structure after a metal filling step in the procedure showing the example of the manufacturing method of metal nanowires according to the embodiment of the present invention.

FIG. 1D is a schematic cross-sectional view of a structure after an isolation step in the procedure showing the example of the manufacturing method of metal nanowires according to the embodiment of the present invention.

FIG. 1E is a schematic cross-sectional view of a structure (metal nanowire) after a crushing step in the procedure showing the example of the manufacturing method of metal nanowires according to the embodiment of the present invention.

FIG. 2 is an image of metal nanowires produced in Example 1, which is captured by a scanning electron microscope (SEM).

FIG. 3 is an image of metal nanowires produced in Comparative Example 1, which is captured by SEM.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In the present specification, a numerical range expressed using “to” means a range including numerical values before and after “to” as a lower limit value and an upper limit value.

### [Composition for Forming Conductive Bonding Material]

The composition for forming a conductive bonding material according to the embodiment of the present invention (hereinafter, also referred to as “composition according to the embodiment of the present invention”) contains at least one conductive material selected from the group consisting of metal nanowires and a metal nanowire aggregate, and a solvent.

In addition, a specific surface area of the conductive material contained in the composition according to the embodiment of the present invention per unit mass is 100 to 50,000 m²/kg.

In addition, a content of the conductive material contained in the composition according to the embodiment of the present invention is 30% by mass or more with respect to the total mass of the composition according to the embodiment of the present invention.

In the present invention, as described above, by using a composition for forming a conductive bonding material, which contains 30% by mass or more of the conductive material such as metal nanowires, having a specific surface area of 100 to 50,000 m²/kg, a conductive bonding material having high conductivity and high bonding strength can be formed.

Here, the reason why the conductive bonding material having high conductivity and high bonding strength can be formed is not clear in detail, but is presumed to be as follows.

First, from the results of Comparative Examples 1 and 3 described later, it is found that, in a case where metal nanowires having a specific surface area of less than 100 m²/kg are used, the bonding strength is deteriorated even in a case where the content thereof is 30% by mass or more.

In addition, from the results of Comparative Examples 2 and 4 described later, it is found that, even in a case where metal nanowires having a specific surface area of 100 to 50,000 m²/kg are used, the conductivity is deteriorated in a case where the content thereof is less than 30% by mass.

Therefore, in the present invention, it is considered that, since the content of the conductive material such as the metal nanowires is 30% by mass or more, the number of bonding sites between the conductive materials such as the metal nanowires is increased, and a conduction path is increased, so that the conductivity is improved.

In addition, it is considered that, since the specific surface area of the conductive material such as the metal nanowires is 100 to 50,000 m²/kg, a proportion of the conductive material existing in a state of being aggregated (for example, a state of being bundled) is reduced, and a proportion of the conductive material existing in a state of being randomly oriented is increased, and flexibility is improved in a case of being used as a bonding material, so that the bonding strength is improved.

### [Conductive Material]

The conductive material contained in the composition according to the embodiment of the present invention is at least one selected from the group consisting of metal nanowires and a metal nanowire aggregate, and has a specific surface area of 100 to 50,000 m²/kg per unit mass.

Here, the “metal nanowires” refers to a conductive substance having a material of a metal, having a needle-like or thread-like shape, and having a diameter of a nanometer size. The metal nanowires may be linear or curved. The material of the metal nanowires is not particularly limited as long as it contains a metal, and may contain a component other than a metal together with the metal.

In addition, the “metal nanowire aggregate” refers to an aggregate of the metal nanowires.

In a case where the specific surface area of the conductive material per unit mass is 100 to 50,000 m²/kg, the conductive material may be only one of the metal nanowires or the metal nanowire aggregate, or may be in an aspect including both.

As described above, the specific surface area of the conductive material contained in the composition according to the embodiment of the present invention per unit mass is 100 to 50,000 m²/kg, preferably more than 100 m²/kg and 50,000 m²/kg or less, more preferably more than 1,000 m²/kg and 50,000 m²/kg or less, still more preferably more than 2,000 m²/kg and 30,000 m²/kg or less, and particularly preferably more than 3,000 m²/kg and 20,000 m²/kg or less.

Here, as the specific surface area per unit mass, a specific surface area of the obtained metal nanowires can be measured by a known analytical method, but in the present invention, a measured value by a krypton gas adsorption method is adopted.

In the present invention, the metal constituting the above-described metal nanowires is not particularly limited, but is preferably a material having an electrical resistivity of 10³ Ω·cm or less; and suitable examples thereof include gold (Au), silver (Ag), copper (Cu), aluminum (Al), titanium (Ti), nickel (Ni), and cobalt (Co).

Among these, from the viewpoint of electrical conductivity, Cu, Au, Al, Ni, or Co is preferable, Cu, Ni, or Co is more preferable, and Cu is still more preferable.

A diameter (arithmetic mean value) of the above-described metal nanowires is preferably 10 to 200 nm, more preferably 10 to 100 nm, and still more preferably 10 to 50 nm.

A length (arithmetic mean value) of the above-described metal nanowires is preferably 0.3 to 300 μm, more preferably 0.5 to 200 μm, and still more preferably 1 μm to 100 μm.

Here, the diameter and the length of the above-described metal nanowires can be determined, for example, by observing an SEM image at a magnification of 100 to 500 times using a field emission scanning electron microscope (FE-SEM). Specifically, the diameter and the length of the metal nanowires refer to average values of measured values of diameters and the lengths of a total of 100 metal nanowires, which are obtained by observing 10 randomly selected the metal nanowires from an SEM image captured at a magnification of 100 to 500 times and measuring the diameters and the lengths thereof in 10 visual fields.

A ratio (length/diameter) of the length to the diameter of the above-described metal nanowires (hereinafter, also referred to as “aspect ratio”) is preferably 10 or more, and more preferably 100 to 1000.

As described above, the content of the conductive material contained in the composition according to the embodiment of the present invention is 30% by mass or more with respect to the total mass of the composition according to the embodiment of the present invention. However, from the reason that dispersion stability over time is maintained well and uniformity during application is improved, the content thereof is preferably 30% to 90% by mass; and from the reason that the conductivity and the bonding strength are further improved and heat dissipation properties are also improved, the content thereof is more preferably 50% to 90% by mass.

### [Production Method of Conductive Material]

From the viewpoint of easily adjusting the specific surface area per unit mass to 100 to 50,000 m²/kg, a production method of the conductive material contained in the composition according to the embodiment of the present invention (hereinafter, also simply referred to as “production method according to the present invention”) is preferably a method including: an anodization step of forming an anodized film having pores on a surface of a valve metal substrate; a metal filling step of filling the pores with a metal; an isolation step of isolating the filling metal from the anodized film and the valve metal substrate; and a crushing step of crushing the isolated metal (hereinafter, also simply referred to as “isolated metal”) to obtain metal nanowires.

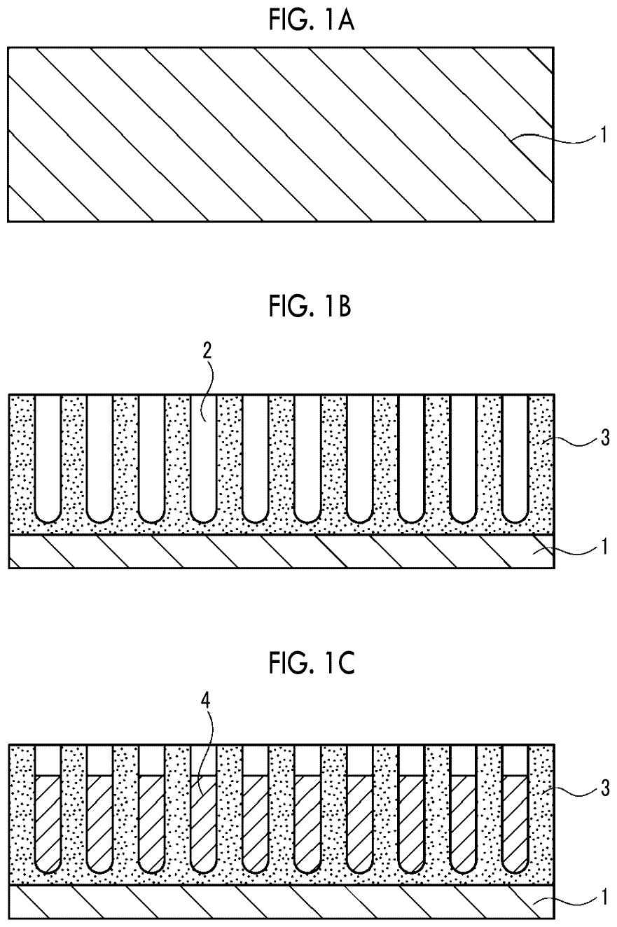

Next, an outline of each step in the production method according to the present invention is described with reference to FIGS. 1A to 1E, and then each treatment step will be described in detail.

As shown in FIGS. 1A and 1B, in the anodization step, a surface of a valve metal substrate 1 is subjected to an anodization treatment to form an anodized film 3 having pores (micropores) 2 on a surface of the valve metal substrate 1.

Next, as shown in FIG. 1C, in the metal filling step, the pores 2 are filled with a metal 4.

Next, as shown in FIG. 1D, in the isolation step, the filling metal 4 is isolated from the anodized film 3 and the valve metal substrate 1. The aspect shown in FIG. 1D shows a state in which an isolated metal 5 obtained by the isolation step is recovered (a state in which a part of the isolated metal is adhered).

Next, as shown in FIG. 1E, in the crushing step, it is possible to obtain a metal nanowire 10 in which the isolated metal 5 is crushed.

### [Valve Metal Substrate]

The valve metal substrate used in the production method according to the present invention is not particularly limited as long as it is a substrate containing a valve metal.

Here, specific examples of the valve metal include aluminum, tantalum, niobium, titanium, hafnium, zirconium, zinc, tungsten, bismuth, and antimony. Among these, aluminum is preferable because it has favorable dimensional stability and is relatively inexpensive.

Therefore, in the production method according to the present invention, it is preferable to use a substrate containing aluminum (hereinafter, referred to as “aluminum substrate”) as the valve metal substrate.

The aluminum substrate is not particularly limited, and specific examples thereof include a pure aluminum plate; an alloy plate having aluminum as a main component and including a trace amount of foreign elements; a substrate obtained by vapor-depositing high-purity aluminum on low-purity aluminum (for example, a recycled material); a substrate obtained by covering a surface of a silicon wafer, quartz, glass, or the like with high-purity aluminum by a method such as vapor deposition and sputtering; and a resin substrate laminated with aluminum.

Among the valve metal substrates, the surface on the side to be subjected to the anodization treatment in the anodization step described later has a valve metal purity of preferably 99.5% by mass or more, more preferably 99.9% by mass or more, and still more preferably 99.99% by mass or more. In a case where the valve metal purity is within the above-described range, regularity of an arrangement of through-passes is sufficient.

In addition, it is preferable that, in the valve metal substrate, the surface on the side to be subjected to the anodization treatment in the anodization step described later is subjected to a heat treatment, a degreasing treatment, and a mirror finishing treatment in advance.

Here, with regard to the heat treatment, the degreasing treatment, and the mirror finishing treatment, the same treatments as those described in paragraphs [0044] to [0054] of JP2008-270158A can be performed.

### [Anodization Step]

The anodization step is a step of subjecting the surface of the above-described valve metal substrate to an anodization treatment to form an anodized film having pores on the surface of the above-described valve metal substrate.

As the anodization treatment performed in the anodization step, a method known in the related art can be used, but it is preferable to use a self-regulation method or a constant voltage treatment in the isolation step described later, because it is possible to isolate filling metal having a small variation in diameter.

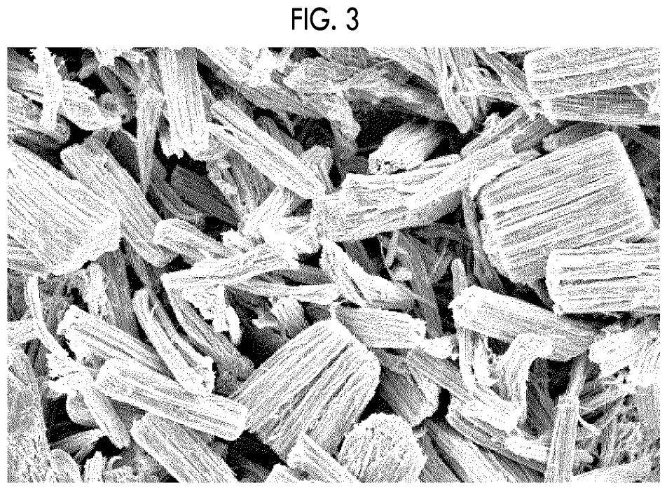

Here, with regard to the self-regulation method or the constant voltage treatment for the anodization treatment, the same treatments as those described in paragraphs [0056] to [0108] and [FIG. 3] of JP2008-270158A can be performed.

For the anodization treatment, for example, a method in which the valve metal substrate is electrically energized as an anode in a solution at an acid concentration of 1% to 10% by mass can be used.

As the solution which is used for the anodization treatment, an acid solution is preferable; sulfuric acid, phosphoric acid, chromic acid, oxalic acid, sulfamic acid, benzenesulfonic acid, amidosulfonic acid, glycolic acid, tartaric acid, malic acid, or citric acid is more preferable; sulfuric acid, phosphoric acid, or oxalic acid is still more preferable; and oxalic acid is particularly preferable. These acids may be used alone or in combination of two or more kinds thereof.

Conditions for the anodization treatment vary depending on an electrolyte to be used, so that the conditions cannot be determined in general. However, in general, the conditions for the anodization treatment are preferably conditions in which an electrolytic solution concentration is 0.1% to 20% by mass, a liquid temperature is −10° C. to 30° C., a current density is 0.01 to 20 A/dm², a voltage is 3 to 300 V, and an electrolysis time is 0.5 to 30 hours; more preferably conditions in which an electrolytic solution concentration is 0.5% to 15% by mass, a liquid temperature is −5° C. to 25° C., a current density is 0.05 to 15 A/dm², a voltage is 5 to 250 V, and an electrolysis time is 1 to 25 hours; and still more preferably conditions in which an electrolytic solution concentration is 1% to 10% by mass, a liquid temperature is 0° C. to 20° C., a current density is 0.1 to 10 A/dm², a voltage is 10 to 200 V, and an electrolysis time is 2 to 20 hours.

A treatment time for the anodization treatment is preferably 0.5 minutes to 16 hours, more preferably 1 minute to 12 hours, and still more preferably 2 minutes to 8 hours.

A thickness of the anodized film formed by the above-described anodization step is not particularly limited, but from the viewpoint of adjusting the length of the metal nanowires, it is preferably 0.3 to 300 μm, more preferably 0.5 to 120 μm, and still more preferably 0.5 to 100 μm.

In order to measure the thickness of the anodized film, the anodized film is cut in a thickness direction with focused ion beams (FIB), a surface photograph (magnification: 50,000 times) of a cross-section thereof is captured with a field emission scanning electron microscope (FE-SEM), and the thickness can be calculated as an average value measured at 10 points.

A density of the pores formed by the above-described anodization step is not particularly limited, but is preferably 2,000,000 pores/mm² or more, more preferably 10,000,000 pores/mm² or more, still more preferably 50,000,000 pores/mm² or more, and particularly preferably 100,000,000 pores/mm² or more.

The density of the pores can be measured and calculated by a method described in paragraphs [0168] and [0169] of JP2008-270158A.

An average opening diameter of the pores formed by the above-described anodization step is not particularly limited, but from the viewpoint of adjusting the diameter of the metal nanowires, it is preferably 5 to 500 nm, more preferably 20 to 400 nm, still more preferably 40 to 200 nm, and particularly preferably 50 to 100 nm.

A surface photograph (magnification: 50,000 times) is captured with FE-SEM, and the average opening diameter of the pores can be calculated as an average value measured at 50 points.

### [Metal Filling Step]

The metal filling step is a step of filling the inside of the pores with a metal after the above-described anodization step.

### <Metal>

Examples of the above-described metal include the same as those described as the metal constituting the metal nanowires above.

### <Filling Method>

Examples of a method for filling the inside of the pores with the above-described metal include the same methods as those described in paragraphs [0123] to [0126] and [FIG. 4] of JP2008-270158A.

In the production method according to the present invention, for the reason that it is difficult for a cavity portion to be included in the produced metal nanowires, it is preferable that the metal filling step includes a plating step.

Specifically, an electrolytic plating treatment method is preferably used as the method for filling the inside of the pores with the above-described metal, and for example, an electrolytic plating method or an electroless plating method can be used.

Here, it is difficult to selectively precipitate (grow) the metal in a hole with a high aspect by an electrolytic plating method known in the related art, which is used for coloration and the like. This is presumed to be because the precipitated metal is consumed in the hole, and thus the plating does not proceed even in a case where electrolysis is carried out for a constant period time or longer.

Therefore, in the production method according to the present invention, in a case where the metal is used for filling by the electrolytic plating method, it is necessary to allow a rest time during pulse electrolysis or constant potential electrolysis. A rest time of 10 seconds or longer is required, and the rest time is preferably 30 to 60 seconds.

In addition, it is also desirable to apply ultrasonic waves to promote stirring of the electrolytic solution.

Furthermore, an electrolytic voltage is usually 20 V or less, desirably 10 V or less, but it is preferable that a precipitation potential of a target metal in the electrolytic solution to be used in advance is measured and constant potential electrolysis is performed within the potential+1 V. In a case of performing the constant potential electrolysis, it is desirable that cyclic voltammetry can be used in combination, and a potentiostat device from Solartron Analytical, BAS Inc., HOKUTO DENKO Corporation, IVIUM Technologies B. V., or the like can be used.

As a plating liquid, a plating liquid known in the related art can be used.

Specifically, a copper sulfate aqueous solution is generally used for precipitating copper, and a concentration of copper sulfate is preferably 1 to 300 g/L and more preferably 100 to 200 g/L. In addition, the precipitation can be promoted by adding hydrochloric acid to the electrolytic solution. In this case, a concentration of hydrochloric acid is preferably 10 to 20 g/L.

In addition, in a case of precipitating gold, it is desirable that a sulfuric acid solution of tetrachloroaurate is used and the plating is performed by alternating current electrolysis.

In the electroless plating method, it takes a long time to fully fill the hole consisting of pores with a high aspect, and thus it is desirable to fill the hole with the metal by the electrolytic plating method in the production method according to the present invention.

In the production method according to the present invention, a treatment method in which an alternating current electrolytic plating method and a direct current electrolytic plating method are combined in this order is preferably used as the electrolytic plating treatment method.

Here, in the alternating current electrolytic plating method, for example, a voltage is applied after sinusoidal modulation at a predetermined frequency. A waveform during the modulation of the voltage is not limited to a sine wave, and can be, for example, a rectangular wave, a triangular wave, a sawtooth wave, or a reverse sawtooth wave.

In addition, the treatment method in the electrolytic plating method described above can be appropriately used for the direct current electrolytic plating method.

In the production method according to the present invention, from the reason that the time for producing the metal nanowires can be shortened, it is preferable that the filling with the metal in the above-described metal filling step is a treatment performed on a region from a bottom of the pore to a middle of an opening portion out of the entire region from the bottom of the pore to the opening portion, as shown in FIG. 1C.

### [Isolation Step]

The above-described isolation step is a step of isolating the filling metal from the above-described anodized film and the above-described valve metal substrate after the above-described metal filling step.

Here, a method for isolating the filling metal from the above-described anodized film and the above-described valve metal substrate is not particularly limited; and suitable examples thereof include a method of removing (for example, dissolving or peeling) the above-described anodized film and the above-described valve metal substrate to isolate the filling metal. Therefore, the aspect after the above-described isolation step includes, for example, an aspect in which the filling metal is dispersed in a state of being isolated in a treatment liquid used in a dissolution step (dissolution treatment) described later.

In the production method according to the present invention, a method for removing the above-described anodized film and the above-described valve metal substrate is not particularly limited, and may be, for example, an aspect in which the removal is carried out by polishing. However, from the reason that the length of the produced metal nanowires is uniform, it is preferable that the above-described isolation step includes a dissolution step, that is, at least a part of the anodized film and the valve metal substrate is removed by a dissolution treatment.

In the production method according to the present invention, from the reason that the shape and size of the metal nanowires to be produced are maintained, the above-described isolation step preferably includes a one-stage removal step of removing the above-described valve metal substrate while removing the above-descried anodized film, and it is preferable that the removal of the anodized film is a step of removing the anodized film by a dissolution treatment.

In addition, for the same reason, the above-described isolation step may be a step including a two-stage removal step of removing the above-described valve metal substrate and then removing the above-described anodized film, and in this case, it is more preferable that the two-stage removal step is a step in which the removal is carried out by a dissolution treatment.

### <Removal of Valve Metal Substrate>

For the removal of the above-described valve metal substrate, a dissolution treatment using a treatment liquid which is difficult to dissolve the anodized film and easily dissolves the valve metal is preferable.

In such a treatment liquid, a dissolution rate for the valve metal is preferably 1 μm/min or more, more preferably 3 μm/min or more, and still more preferably 5 μm/min or more. In addition, a dissolution rate for the anodized film is preferably 0.1 nm/min or less, more preferably 0.05 nm/min or less, and still more preferably 0.01 nm/min or less.

Specifically, the treatment liquid is preferably a treatment liquid containing at least one metal compound having an ionization tendency lower than that of the valve metal and having a pH of 4 or less or 8 or more, in which the pH is more preferably 3 or less or 9 or more and still more preferably 2 or less or 10 or more.

Such a treatment liquid is preferably a treatment liquid obtained by formulating, for example, a compound of manganese, zinc, chromium, iron, cadmium, cobalt, nickel, tin, lead, antimony, bismuth, copper, mercury, silver, palladium, platinum, or gold (for example, chloroplatinic acid), fluorides of these metals, and chlorides of these metals, based on an acid or alkali aqueous solution.

Among these, an acid aqueous solution-based treatment liquid is preferable, and a chloride-blended treatment liquid is preferable.

In particular, from the viewpoint of treatment latitude, a treatment liquid obtained by blending mercury chloride with a hydrochloric acid aqueous solution (hydrochloric acid/mercuric chloride) or a treatment liquid obtained by blending copper chloride with a hydrochloric acid aqueous solution (hydrochloric acid/copper chloride) is preferable.

A formulation of such a treatment liquid is not particularly limited, and for example, a bromine/methanol mixture, a bromine/ethanol mixture, aqua regia, or the like can be used.

In addition, a concentration of the acid or the alkali of such a treatment liquid is preferably 0.01 to 10 mol/L and more preferably 0.05 to 5 mol/L.

Furthermore, a treatment temperature at which such a treatment liquid is used is preferably −10° C. to 80° C. and more preferably 0° C. to 60° C.

In addition, the above-described removal of the valve metal substrate is performed by bringing the valve metal substrate after the above-described metal filling step into contact with the above-described treatment liquid. A contact method is not particularly limited, and examples thereof include a dipping method and a spraying method. Among these, a dipping method is preferable. A contact time in this case is preferably 10 seconds to 5 hours, and more preferably 1 minute to 3 hours.

### <Removal of Anodized Film>

For the removal of the above-described anodized film, a solvent which does not dissolve the metal filled in the pores and selectively dissolves the anodized film can be used, and either an alkali aqueous solution or an acid aqueous solution can be used.

Here, in a case where the alkali aqueous solution is used, it is preferable to use an aqueous solution of at least one alkali selected from the group consisting of sodium hydroxide, potassium hydroxide, and lithium hydroxide, and it is more preferable to use an aqueous solution of potassium hydroxide. In addition, a concentration of the alkali aqueous solution is preferably 1% to 30% by mass. A temperature of the alkali aqueous solution is preferably 10° C. to 60° C., more preferably 20° C. to 60° C., and still more preferably 30° C. to 60° C.

On the other hand, in a case where the acid aqueous solution is used, it is preferable to use an aqueous solution of an inorganic acid such as chromic acid, sulfuric acid, phosphoric acid, nitric acid, hydrochloric acid, and oxalic acid, or an aqueous solution of a mixture of these acids, and it is more preferable to use an aqueous solution of chromic acid. In addition, a concentration of the acid aqueous solution is preferably 1% to 30% by mass. A temperature of the acid aqueous solution is preferably 15° C. to 80° C., more preferably 20° C. to 60° C., and still more preferably 30° C. to 50° C.

In addition, the above-described removal of the anodized film is carried out by bringing the anodized film into contact with the above-described alkali aqueous solution or the above-described acid aqueous solution after the above-described metal filling step (preferably, after removing the valve metal substrate). A contact method is not particularly limited, and examples thereof include a dipping method and a spraying method. Among these, a dipping method is preferable. A time of dipping in the alkali aqueous solution or the acid aqueous solution is preferably 1 to 120 minutes, more preferably 2 to 90 minutes, still more preferably 3 to 60 minutes, and particularly preferably 3 to 30 minutes. Among these, the time is preferably 3 to 20 minutes, and more preferably 3 to 10 minutes.

### [Crushing Step]

The crushing step is a step of crushing step the isolated metal after the above-described isolation step.

A method of crushing the isolated metal is not particularly limited, and suitable examples thereof include a method of crushing the isolated metal by applying an impact to the isolated metal in a liquid.

The liquid (solvent) used for the crushing is not particularly limited as long as the isolated metal is not altered and dissolved; and examples thereof include water, ethanol, methanol, acetone, methyl ethyl ketone, butanol, ethyl acetate, butyl acetate, tetrahydrofuran, toluene, dimethylformamide, cyclohexane, and cyclohexanone. Among these, water is preferable from the viewpoint of safety.

In addition, from the viewpoint of being able to produce metal nanowires having a higher bonding strength during bonding, the above-described crushing step is preferably carried out in water or in an aqueous solution in which a concentration of alkali or acid is less than 1% by mass.

Examples of the crushing treatment include a crushing treatment using cavitation and a crushing treatment in which ceramic balls are made to collide with each other; and a device such as an ultrasonic cleaner, an ultrasound homogenizer, a jet mill, and a wet-type miniaturization device can be used. Among these, a crushing treatment using cavitation or a crushing treatment in which ceramic balls are made to collide with each other is preferable, and a crushing treatment using cavitation is more preferable.

In the present invention, a concentration of the isolated metal in the liquid in a case of decomposing the pressure in the liquid is preferably 0.1% to 50% by mass because the treatment is uniform and the productivity is improved.

In addition, the concentration of the isolated metal in the liquid in a case of decomposing the pressure in the liquid is more preferably 0.5% to 30% by mass, and still more preferably 1% to 10% by mass, from the viewpoint of being able to produce metal nanowires having a higher bonding strength during bonding.

### [Drying Step]

From the reason that the effect of the present invention, in which the metal nanowires having a high bonding strength during bonding can be obtained, is manifested, it is preferable that the production method according to the present invention further includes, between the above-described isolation step and the above-described crushing step, a drying step of drying the isolated metal.

Here, a method for drying the isolated metal is not particularly limited, but the isolated metal can be dried by carrying out a separation operation such as filtration using a filter or the like or centrifugation after removing the above-described anodized film and the above-described valve metal substrate, thereby recovering the isolated metal.

### [Protective Layer Forming Step]

From the viewpoint of obtaining metal nanowires with a low connection resistance, it is preferable that the production method according to the present invention further includes a step of forming a protective layer containing a corrosion inhibitor on the isolated metal after the above-described isolation step (in a case where the above-described drying step is included, after the drying step).

The above-described corrosion inhibitor is not particularly limited, and a known corrosion inhibitor can be applied.

Examples of the corrosion inhibitor include a compound containing at least one of a nitrogen atom, an oxygen atom, or a sulfur atom.

From the viewpoint of durability, the corrosion inhibitor is preferably a heterocyclic compound containing at least one of a nitrogen atom or an oxygen atom; more preferably a compound including a 5-membered ring structure containing one or more nitrogen atoms; and particularly preferably at least one compound selected from the group consisting of a compound including a triazole structure, a compound including a benzimidazole structure, and a compound including a thiadiazole structure. The 5-membered ring structure containing one or more nitrogen atoms may be a monocyclic structure or a partial structure constituting a fused ring.

In addition, from the reason that the corrosion inhibitor is easily adsorbed on the surface of the isolated metal, it is preferable that the corrosion inhibitor is a compound containing at least one of a polar group-containing acid or a polar group-containing base.

Examples of a polar group contained in the polar group-containing acid and in the polar group-containing base include a carboxylic acid group (carboxy group), a sulfonic acid group (sulfo group), a phosphonic acid group, a phosphoric acid group, primary to quaternary ammonium bases, a carboxylate group, a sulfonate group, a phosphonate group, and a phosphate group.

In addition, the corrosion inhibitor is preferably a compound containing a carboxy group from the reason that it is bonded with a metal ion to form a complex ion and the surface of the isolated metal is easily protected.

Specific examples of the above-described corrosion inhibitor include imidazole, benzimidazole, 1,2,4-triazole, benzotriazole (BTA), tolyltriazole (TTA), butylbenzyltriazole, alkyldithiothiadiazole, alkylthiol, 2-aminopyrimidine, 5,6-dimethylbenzimidazole, 2-amino-5-mercapto-1,3,4-thiadiazole, 2,5-dimercapto-1,3,4-thiadiazole (DMTDA), 2-mercaptopyrimidine, 2-mercaptobenzoxazole, 2-mercaptobenzothiazole (MBT), and 2-mercaptobenzimidazole.

Other specific examples of the above-described corrosion inhibitor include aliphatic carboxylic acids such as acetic acid, propionic acid, palmitic acid, stearic acid, lauric acid, arachidic acid, terephthalic acid, and oleic acid; carboxylic acids such as glycolic acid, lactic acid, oxalic acid, malic acid, tartaric acid, and citric acid; amino polycarboxylic acids such as ethylenediaminetetraacetic acid (EDTA), nitrilotriacetic acid (NTA), iminodiacetic acid (IDA), ethylenediaminediacetic acid (EDDA), and ethylene glycol diethyl ether diaminetetraacetic acid (GEDA); uric acid; and gallic acid.

The corrosion inhibitor may be used alone or in appropriate combination of two or more kinds thereof.

In addition, from the reason that temporal stability is improved, it is preferable that the above-described corrosion inhibitor includes a compound containing a nitrogen atom (nitrogen-containing compound), it is more preferable that the corrosion inhibitor is a nitrogen-containing compound, and it is still more preferable that the corrosion inhibitor is a heterocyclic compound containing at least one of a nitrogen atom or a sulfur atom.

A method for forming the protective layer containing such a corrosion inhibitor is not particularly limited; and examples thereof include a method of adding the isolated metal recovered in the above-described drying step to an aqueous solution containing the corrosion inhibitor and stirring the mixture, and a method of adding the corrosion inhibitor to a washing solvent for washing the isolated metal recovered in the above-described drying step.

### [Reduction or Removal Step]

From the viewpoint of obtaining metal nanowires with a low connection resistance, it is preferable that the production method according to the present invention further includes, between the above-described isolation step and the above-described crushing step (in a case where the above-described drying step is included, before the drying step), a step of reducing or removing a surface oxide layer of the isolated metal.

Examples of the reduction or removal step include a step of performing an immersion treatment using the alkali aqueous solution and the acid aqueous solution in the treatment for removing the anodized film described above.

### [Solvent]

As the solvent contained in the composition according to the embodiment of the present invention, an organic solvent is mainly used; and in a case where an organic solvent miscible with water is used, water can be used together with the organic solvent at a proportion of 20% by volume or less.

As the above-described organic solvent, for example, an alcohol-based compound having a boiling point of 50° C. to 250° C., more preferably 55° C. to 200° C., is suitably used. By using such an alcohol-based compound in combination, the application in the coating step during the formation of the conductive film can be improved and drying load can be reduced.

The above-described alcohol-based compound is not particularly limited, and is appropriately selected depending on the intended purpose. Specific examples thereof include polyethylene glycol, polypropylene glycol, alkylene glycol, and glycerol; and these may be used alone or in combination of two or more kinds thereof.

Specifically, a compound having a small number of carbon atoms, such as ethylene glycol, diethylene glycol, 1,2-propanediol, 1,3-propanediol, 1,2-butanediol, 1,3-butanediol, 1,4-butanediol, and 2,3-butanediol, each of which has a low viscosity at room temperature, is preferable; but a compound having a large number of carbon atoms, such as pentanediol, hexanediol, octanediol, and polyethylene glycol, can also be used.

Among these, the most preferred solvent is diethylene glycol.

### [Surfactant]

In the composition according to the embodiment of the present invention, it is preferable to use a surfactant because dispersion stability is further improved.

Examples of the above-described surfactant include a nonionic surfactant, an anionic surfactant, a cationic surfactant, an amphoteric surfactant, and a fluorine-based surfactant; and these may be used alone or in combination of two or more kinds thereof.

The nonionic surfactant is not particularly limited, and a nonionic surfactant known in the related art can be used.

Examples thereof include polyoxyethylene alkyl ethers, polyoxyethylene alkylphenyl ethers, polyoxyethylene-polystyryl phenyl ethers, polyoxyethylene-polyoxypropylene alkyl ethers, partial fatty acid esters of glycerol, partial fatty acid esters of sorbitan, partial fatty acid esters of pentaerythritol, monoesters of fatty acids with propylene glycol, partial fatty acid esters of sucrose, partial fatty acid esters of polyoxyethylene sorbitan, partial fatty acid esters of polyoxyethylene-sorbitol, polyethylene glycol fatty acid esters, partial fatty acid esters of polyglycerol, polyoxyethylated castor oils, partial fatty acid esters of polyoxyethylene glycerol, fatty acid diethanolamides, N,N-bis-2-hydroxyalkylamines, polyoxyethylene alkylamines, triethanolamine fatty acid esters, trialkylamine oxides, polyethylene glycols (for example, polyethylene glycol monostearate and the like), and copolymers of polyethylene glycol and polypropylene glycol.

The anionic surfactant is not particularly limited, and an anionic surfactant known in the related art can be used.

Examples thereof include fatty acid salts, abietic acid salts, hydroxyalkanesulfonic acid salts, alkanesulfonic acid salts, dialkylsulfosuccinic acid salts, linear alkylbenzenesulfonic acid salts, branched alkylbenzenesulfonic acid salts, alkylnaphthalenesulfonic acid salts, alkylphenoxypolyoxyethylenepropylsulfonic acid salts, polyoxyethylene alkylsulfophenyl ether salts, N-methyl-N-oleyltaurine sodium salts, N-alkylsulfosuccinic acid monoamide disodium salts, petroleumsulfonic acid salts, sulfonated tallow oil, sulfuric acid ester salts of fatty acid alkyl esters, alkylsulfuric acid ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkylphosphoric acid ester salts, polyoxyethylene alkyl ether phosphoric acid ester salts, polyoxyethylene alkylphenyl ether phosphoric acid ester salts, partially saponified styrene/maleic acid anhydride copolymers, partially saponified olefin/maleic anhydride copolymers, and naphthalenesulfonic acid salt/formalin condensates.

The cationic surfactant is not particularly limited, and a cationic surfactant known in the related art can be used. Examples thereof include alkylamine salts, quaternary ammonium salts, polyoxyethylene alkylamine salts, and polyethylene polyamine derivatives.

The amphoteric surfactant is not particularly limited, and an amphoteric surfactant known in the related art can be used. Examples thereof include carboxybetaines, aminocarboxylic acids, sulfobetaines, aminosulfuric acid esters, and imidazoline compounds.

In the above-described surfactants, “polyoxyethylene” can be replaced by “polyoxyalkylene” such as polyoxymethylene, polyoxypropylene, and polyoxybutylene; and these surfactants also can be used in the present invention.

In the present invention, preferred examples of the surfactant include a fluorine-based surfactant containing a perfluoroalkyl group in the molecule.

Examples of such a fluorine-based surfactant include anionic fluorine-based surfactants such as perfluoroalkanecarboxylic acid salts, perfluoroalkanesulfonic acid salts, and perfluoroalkylphosphoric acid esters; amphoteric fluorine-based surfactants such as perfluoroalkyl betaines; cationic fluorine-based surfactants such as perfluoroalkyltrimethylammonium salts; and nonionic fluorine-based surfactants such as perfluoroalkylamine oxides, perfluoroalkyl ethylene oxide adducts, oligomers having a perfluoroalkyl group and a hydrophilic group, oligomers having a perfluoroalkyl group and a lipophilic group, oligomers having a perfluoroalkyl group, a hydrophilic group, and a lipophilic group, and urethanes having a perfluoroalkyl group and a lipophilic group. In addition, fluorine-based surfactants described in JP1987-170950A (JP-S62-170950A), JP1987-226143A (JP-S62-226143A), and JP1985-168144A (JP-S60-168144A) are also suitable.

In addition, in the present invention, from the reason that dispersion stability is further improved, among the surfactants, a surfactant having an HLB value of 10 or more is desirably used.

Here, the hydrophile-lipophile balance (HLB) value is a value representing a degree of affinity of the surfactant to water and oil (an organic compound insoluble in water). The HLB value is a value from 0 to 20; and as the value is closer to 0, lipophilicity is higher, and as the value is closer to 20, hydrophilicity is higher.

In the present invention, the surfactants may be used alone or in combination of two or more kinds thereof.

In addition, a content of the surfactants is preferably 0.001% to 10% by mass and more preferably 0.01% to 5% by mass with respect to the total mass of the above-described conductive material.

### [Water-Soluble Dispersant]

In the composition according to the embodiment of the present invention, a water-soluble organic molecule having a hydroxyl group, a carboxyl group, a sulfone group, a phosphate group, an amino group, an SH group, or the like at a terminal, for example, a water-soluble dispersant such as succinic acid, polyvinyl alcohol (PVA), and polyvinylpyrrolidone (PVP) can be used.

### [Conductive Particles]

The composition according to the embodiment of the present invention may further contain conductive particles in addition to the above-described conductive material.

Here, the conductive particles preferably contain a metal, and more preferably contain at least one metal selected from the group consisting of gold, silver, copper, aluminum, nickel, zinc, and cobalt.

In addition, the conductive particles may contain one kind or two or more kinds of conductive components other than a metal.

In the present invention, a shape of the conductive particles is not particularly limited, and may be solid or hollow.

In addition, from the reason that a space can be more densely filled with the metal with respect to the thickness of the conductive bonding material described later, an average major diameter of the conductive particles in a minimum enclosing ellipsoid is preferably 0.01 μm or more and 50 μm or less, and more preferably 0.1 μm or more and 20 μm or less.

In addition, from the viewpoint of selecting a shape which efficiently fills the space, the average major diameter of the conductive particles in the minimum enclosing ellipsoid is preferably 1 to 10 times an average minor diameter.

Here, the minimum enclosing ellipsoid refers to an ellipsoid having the smallest volume among ellipsoids containing the conductive particles inside, and also includes an ellipsoid in which the major axis and the minor axis are the same (that is, a sphere).

In addition, the average major diameter in the minimum enclosing ellipsoid can be determined by observing a cross-section of a layer formed of the dispersion liquid in the thickness direction with a microscope (for example, an electron microscope), measuring major diameters of 100 fine particles to obtain an arithmetic mean value thereof. Similarly, the average minor diameter in the minimum enclosing ellipsoid can be determined by observing a cross-section of a layer formed of the dispersion liquid in the thickness direction with a microscope (for example, an electron microscope), measuring minor diameters of 100 fine particles to obtain an arithmetic mean value thereof.

Furthermore, a median diameter (D50) described later refers to a median diameter of diameters in a case where the volume of the conductive particles is approximated to the sphere, and can be determined by a laser diffraction/light scattering method or a dynamic light scattering method.

In a case where the composition according to the embodiment of the present invention contains the conductive particles, a content of the conductive particles is not particularly limited, but is preferably 5 to 70 parts by mass and more preferably 10 to 45 parts by mass with respect to 100 parts by mass of the metal nanowires.

### [Resin Material]

From the viewpoint of improving adhesiveness, it is preferable that the composition according to the embodiment of the present invention further contains a resin material.

Examples of the resin material include an epoxy resin, an acrylic resin, and a urethane resin; and among these, an epoxy resin is preferable.

Specific examples of the epoxy resin include an epoxy resin having a naphthalene skeleton, a bisphenol A-type epoxy resin, a bisphenol F-type epoxy resin, a phenol novolac-type epoxy resin, an alicyclic epoxy resin, a siloxane-type epoxy resin, a biphenyl-type epoxy resin, a glycidyl ester-type epoxy resin, a glycidyl amine-type epoxy resin, and a hydantoin-type epoxy resin; and these may be used alone or in combination of two or more kinds thereof.

In particular, from the viewpoint of moldability of the film, the epoxy resin is preferably an epoxy resin having a naphthalene skeleton, a bisphenol A-type epoxy resin, or a bisphenol F-type epoxy resin, which is in a liquid state at normal temperature.

### [Epoxy Resin Curing Agent]

In a case where the composition according to the embodiment of the present invention contains the epoxy resin, it is preferable that the composition according to the embodiment of the present invention contains an epoxy resin curing agent, that is, a catalyst which promotes a curing reaction of the epoxy resin.

As the epoxy resin curing agent, for example, an imidazole-based curing agent, a phenol-based curing agent, an amine-based curing agent, an acid anhydride-based curing agent, an organic peroxide-based curing agent, or the like can be used. In particular, from the viewpoint of storability (life) of the composition according to the embodiment of the present invention at normal temperature, the epoxy resin curing agent is preferably a curing agent having latent property, and more preferably an imidazole-based curing agent having latent property in a state of being encapsulated. In a case where the storability at normal temperature is improved, it is possible to more easily manage the supply and use of the composition according to the embodiment of the present invention. Specifically, as the epoxy resin curing agent, a microcapsule-type latent curing agent in which a latent imidazole-modified substance is used as a nucleus and a surface thereof is coated with polyurethane can be used. As a commercially available product thereof, for example, NOVACURE 3941 (manufactured by Asahi Kasei E-Materials Corporation) can be used. The epoxy resin curing agent may be used alone or in combination of two or more kinds thereof.

In a case where the composition according to the embodiment of the present invention contains the epoxy resin and the epoxy resin curing agent, the total content of the epoxy resin and the epoxy resin curing agent is preferably 50% by mass or less, more preferably 30% by mass or less, and still more preferably 10% to 20% by mass with respect to the total mass of the composition according to the embodiment of the present invention.

### [Reducing Agent]

The composition according to the embodiment of the present invention may contain a reducing agent.

Examples of the reducing agent include hydrazine compounds such as hydrazine, a hydrazine derivative, hydrazine hydrochloride, hydrazine sulfate, and hydrazine monohydrate; hydroxylamine compounds such as hydroxylamine and a hydroxylamine derivative; and sodium compounds such as sodium borohydride, sodium sulfite, sodium hydrogen sulfite, sodium thiosulfate, and sodium hypophosphite; and the like. These compounds may be used alone or in combination of two or more kinds thereof.

### [Conductive Bonding Material]

The conductive bonding material according to the embodiment of the present invention is a conductive bonding material formed of the above-described composition according to the embodiment of the present invention. A shape of the conductive bonding material is not particularly limited, and the conductive bonding material may be, for example, in a form of a paste or a sheet.

In addition, the conductive bonding material according to the embodiment of the present invention can be suitably used as a conductive bonding material which is used for, for example, a semiconductor bonding member, a touch panel, a display electrode bonding material, an electromagnetic wave shield, a sintering material, an electrode material for a thin layer ceramic capacitor, or various other devices.

### [Manufacturing Method of Conductive Bonding Material]

The manufacturing method of a conductive bonding material according to the embodiment of the present invention is a manufacturing method including a step of supplying the above-described composition according to the embodiment of the present invention onto a substrate.

Here, the above-described substrate is not particularly limited, and examples of a material thereof include polyethylene terephthalate, polytetrafluoroethylene, polyimide, polyether ether ketone (PEEK), aluminum, glass, alumina, silicon nitride, and stainless steel. A cloth coated or infused with the above-described material may be used as the substrate. In addition, the above-described substrate may be a temporary support which can be peeled off after the supply of the composition.

In addition, as a method for supplying the composition according to the embodiment of the present invention, for example, ink jet printing, screen printing, a jet printing method, a dispenser, a jet dispenser, a comma coater, a slit coater, a die coater, a gravure coater, a slit coating, a relief printing, an intaglio printing, a gravure printing, a stencil printing, a bar coating, an applicator, a spray coater, electrodeposition painting, or the like can be used.

The manufacturing method of a conductive bonding material according to the embodiment of the present invention may include a step of drying the composition according to the embodiment of the present invention, which has been supplied onto the substrate. In addition, the composition according to the embodiment of the present invention can be separated from the substrate as a self-supporting sheet by the drying.

As the above-described drying method, drying by allowing the composition to stand at normal temperature, heating drying, or drying under reduced pressure can be used. A hot plate, a hot air dryer, a hot air heating furnace, a nitrogen dryer, an infrared dryer, an infrared heating furnace, a far infrared heating furnace, a microwave heating device, a laser heating device, an electromagnetic heating device, a heater heating device, a steam heating furnace, a hot plate pressing device, or the like can be used for the heating drying or the drying under reduced pressure. The drying temperature and time are preferably appropriately adjusted according to the type and amount of a dispersion medium used, and for example, the drying is preferably carried out at 50° C. to 300° C. for 1 to 180 minutes.

In addition, from the viewpoint of suppressing oxidation of the metal, the drying may be carried out in a non-oxidizing atmosphere or a reducing atmosphere. Examples thereof include replacement with non-oxidizable gases such as argon, nitrogen, and water vapor, and spraying with hydrogen and formic acid.

### [Device]

The device according to the embodiment of the present invention is a device including the above-described conductive bonding material according to the embodiment of the present invention and a member provided on at least one surface of the conductive bonding material, in which the member is at least one selected from the group consisting of a semiconductor element, an electrode, and a wiring line.

Here, examples of the above-described member include semiconductor elements, electrodes, and wiring lines, which are used for the above-described applications of the conductive bonding material according to the embodiment of the present invention, that is, a semiconductor bonding member, a touch panel, a display electrode bonding material, an electromagnetic wave shield, a sintering material, an electrode material for a thin layer ceramic capacitor, or various other devices.

In addition, the device according to the embodiment of the present invention may have an underfill.

Here, typical examples of a composition forming the underfill include a composition containing an epoxy resin, a curing agent, and an inorganic filler. Examples of such a composition include compositions described in JP2014-091744A, JP2014-192238A, JP2015-021122A, JP2015-032639A, JP2015-053436A, JP2015-056464A, JP2015-140389A, and JP2017-008312A.

### EXAMPLES

Hereinafter, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to Examples.

### Example 1

### <Production of Aluminum Substrate>

A molten metal was produced using an aluminum alloy containing 0.06% by mass of Si, 0.30% by mass of Fe, 0.005% by mass of Cu, 0.001% by mass of Mn, 0.001% by mass of Mg, 0.001% by mass of Zn, and 0.03% by mass of Ti and, as the remainder, Al and unavoidable impurities, a molten metal treatment and filtration were performed, and an ingot having a thickness of 500 mm and a width of 1,200 mm was produced according to a direct chill (DC) casting method.

Next, the surface was scraped off using a surface grinder having an average thickness of 10 mm and heated at 550° C. and maintained the state for approximately 5 hours. After the temperature was decreased to 400° C., a rolled sheet having a thickness of 2.7 mm was obtained using a hot rolling mill.

Furthermore, the rolled plate was subjected to a heat treatment at 500° C. using a continuous annealing machine, and then subjected to cold rolling to be finished to a thickness of 1.0 mm, thereby obtaining an aluminum substrate in accordance to Japanese Industrial Standards (JIS) 1050 Material.

The aluminum substrate was formed into a wafer shape with a diameter of 200 mm (8 inches), and then subjected to each of the following treatments.

### <Electropolishing Treatment>

The above-described aluminum substrate was subjected to an electropolishing treatment using an electropolishing liquid having the following formulation under conditions of a voltage of 25 V, a liquid temperature of 65° C., and a liquid flow rate of 3.0 m/min.

A carbon electrode was used as a cathode, and GP0110-30R (manufactured by TAKASAGO Ltd.) was used as a power source. In addition, the flow rate of the electrolytic solution was measured using a vortex flow monitor FLM22-10PCW (manufactured by AS ONE Corporation).

(Formulation of electropolishing liquid)

| | |
|---|---|
| 85% by mass of phosphoric acid (reagent manufactured by | 660 mL |
| FUJIFILM Wako Pure Chemical Corporation) | |
| Pure water | 160 mL |
| Sulfuric acid | 150 mL |
| Ethylene glycol | 30 mL |

### <Anodization Step>

Next, the aluminum substrate after the electropolishing treatment was subjected to an anodization treatment by a self-regulation method according to the procedure described in JP2007-204802A.

The aluminum substrate after the electropolishing treatment was subjected to a pre-anodization treatment for 5 hours using an electrolytic solution of 0.50 mol/L of oxalic acid, under conditions of a voltage of 40 V, a liquid temperature of 16° C., and a liquid flow rate of 3.0 m/min.

Thereafter, the aluminum substrate subjected to the pre-anodization treatment was immersed for 12 hours in a mixed aqueous solution (liquid temperature: 50° C.) of 0.2 mol/L of chromic acid anhydride and 0.6 mol/L phosphoric acid to perform a film removal treatment.

Thereafter, the aluminum substrate was subjected to a re-anodization treatment for 5 hours using an electrolytic solution of 0.50 mol/L of oxalic acid, under conditions of a voltage of 40 V, a liquid temperature of 16° C., and a liquid flow rate of 3.0 m/min, thereby obtaining an anodized film having a film thickness of 40 μm.

In the pre-anodization treatment and the re-anodization treatment, a stainless steel electrode was used as a cathode, and GP0110-30R (manufactured by TAKASAGO Ltd.) was used as a power source. In addition, NeoCool BD36 (manufactured by Yamato Scientific Co., Ltd.) was used as a cooling device, and PAIRSTIRRER PS-100 (manufactured by TOKYO RIKAKIKAI CO., LTD.) was used as a stirring and heating device. Furthermore, the flow rate of the electrolytic solution was measured using a vortex flow monitor FLM22-10PCW (manufactured by AS ONE Corporation).

### <Metal Filling Step>

Next, the aluminum substrate was used as a cathode, and platinum was used as a positive electrode for an electrolytic plating treatment.

Specifically, a copper plating liquid having the formulation shown below was used, and constant current electrolysis was carried out to produce a metal-filled microstructure in which copper was filled inside pores (micropores).

Here, for the constant current electrolysis, a plating device manufactured by YAMAMOTO-MS Co., Ltd. was used, and a power source (HZ-3000) manufactured by HOKUTO DENKO Corporation was used, cyclic voltammetry was carried out in the plating liquid, and then after checking precipitation potential, the treatment was carried out under the conditions shown below.

(Formulation and conditions of copper plating liquid)

| | | |
|---|---|---|
| Copper sulfate | 100 | g/L |
| Sulfuric acid | 50 | g/L |
| Hydrochloric acid | 15 | g/L |
| Temperature | 25° | C. |
| Current density | 10 | A/dm² |

A surface of the anodized film after filling the pores with the metal was observed with FE-SEM, and in a case where the presence or absence of sealing with the metal in 1000 pores was observed to calculate a sealing rate (the number of pores to be sealed/1000), the sealing rate was 96%.

In addition, the anodized film after filling the pores with the metal was cut with FIB in the thickness direction, and in a case where a surface photograph (magnification: 50,000 times) of a cross-section thereof was captured with FE-SEM to confirm the inside of the pores, it was confirmed that a filling height from the bottom of the pores was 35 μm.

### <Isolation Step>

The filling metal was isolated from the anodized film and the aluminum substrate by immersing the filling metal in a potassium hydroxide aqueous solution (concentration: 5 mol/L) at 60° C. for 300 seconds, thereby obtaining an isolated metal. Specifically, the anodized film was dissolved by immersing the film in a potassium hydroxide aqueous solution (concentration: 5 mol/L) at 60° C. for 300 seconds, and the aluminum substrate was peeled off at the same time as the anodized film was dissolved (at a point in time when 300 seconds had elapsed), thereby isolating the filling metal.

### <Drying Step>

Next, the isolated metal was recovered by suction filtration using a membrane (0.4 μm, PTFE, manufactured by Omnipore), and the isolated metal was dried.

### <Washing, Protective Layer Forming Step, and Reduction or Removal Step>

Next, the isolated metal recovered on the membrane was washed for 1 minute using a washing solvent shown below. In Example 1, a protective layer was formed at the same time as the washing because a corrosion inhibitor was added to the washing solvent. In addition, in Example 1, since citric acid was used as the corrosion inhibitor, the removal of the surface oxide layer of the isolated metal was also carried out at the same time as the formation of the protective layer.

Thereafter, the isolated metal on the membrane was recovered.

### (Washing Solvent)

Aqueous solution containing 1% by mass of citric acid

### <Crushing Step>

Next, the recovered isolated metal was added to water at 1% by mass, and the mixture was subjected to a crushing treatment by cavitation (pressure: 50 MPa) once using Star Burst Mini manufactured by SUGINO MACHINE LIMITED.

Thereafter, the isolated metal subjected to the crushing treatment was recovered by suction filtration using a membrane (0.4 μm, PTFE, manufactured by Omnipore) and dried under reduced pressure for 12 hours to produce metal nanowires.

Here, in a case where a specific surface area was measured by a krypton gas adsorption method after a treatment under reduced pressure at 50° C. for 60 minutes using BELSORP-max manufactured by MicrotracBEL Corp., it was 7000 m²/kg.

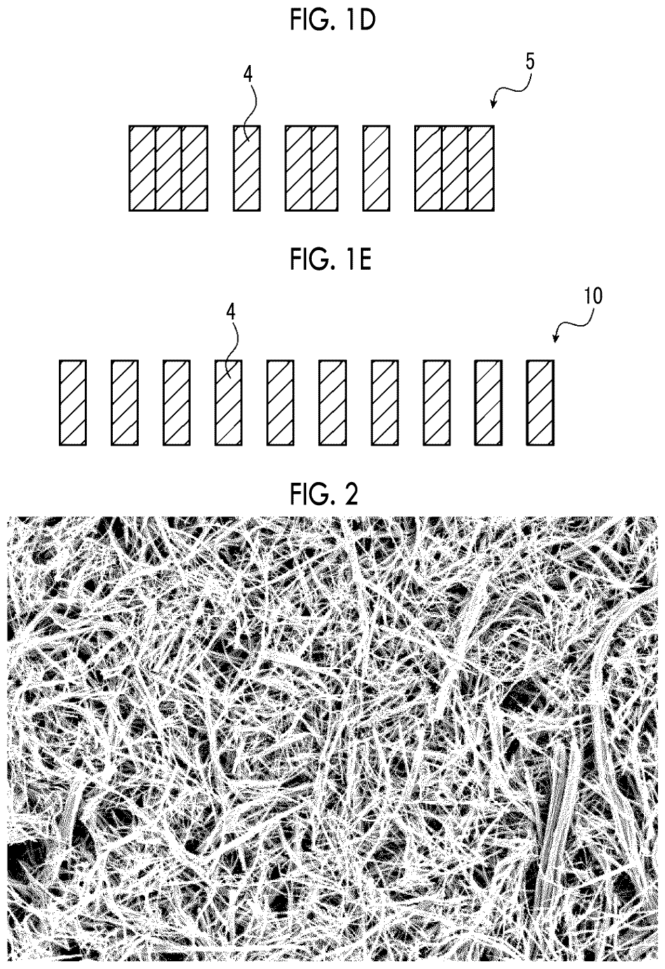

In addition, an SEM image (magnification: 2,000 times) of the produced metal nanowires is shown in FIG. 2.

### <Preparation of Composition (Paste)>

Next, the recovered metal nanowires were added to polyethylene glycol (molecular weight: 200) such that the concentration was 80 wt %, and a paste was prepared by centrifugal stirring using AWATORI RENTARO (ARE-400TWIN, manufactured by THINKY Corporation).

### Example 2

A paste was prepared by the same method as in Example 1, except that the metal nanowires recovered by the same method as in Example 1 were 68% by mass, and polyethylene glycol (molecular weight: 200) was added to a mixture of the metal nanowires, 7.2% by mass of a bisphenol A-type epoxy resin (YD014, manufactured by NIPPON STEEL & SUMITOMO METAL CORPORATION), and 4.8% by mass of a microcapsule-type latent curing agent (NOVACURE 3941, manufactured by Asahi Kasei E-Materials Corporation), which was obtained by using an imidazole-modified substance as a nucleus and coating the surface thereof with polyurethane, such that the content of the polyethylene glycol was 20% by mass with respect to the total amount.

### Example 3

A paste was prepared by the same method as in Example 2, except that the pressure in the crushing step was set to 100 MPa and the number of times of use was set to 5 times.

### Example 4

A paste was prepared by the same method as in Example 2, except that the content of the metal nanowires recovered by the same method as in Example 1 was changed to 56% by mass, and 12% by mass of conductive fine particles A having both an average major diameter and an average minor diameter of 3.5 μm was further added thereto.

### Example 5

A paste was prepared by the same method as in Example 4, except that conductive fine particles B having an average major diameter of 3.1 μm and an average minor diameter of 500 nm were added instead of the conductive fine particles A.

### Example 6

A paste was prepared by the same method as in Example 4, except that the conductive fine particles A were changed to conductive fine particles C having an average major diameter of 25 μm and an average minor diameter of 17 μm.

### Example 7

A paste was prepared by the same method as in Example 2, except that the content of the metal nanowires recovered by the same method as in Example 1 was changed to 61.6% by mass, and 6.4% by mass of conductive fine particles A having both an average major diameter and an average minor diameter of 3.5 μm was further added thereto.

### Example 8

A paste was prepared by the same method as in Example 2, except that the content of the metal nanowires recovered by the same method as in Example 1 was changed to 66.4% by mass, and 1.6% by mass of conductive fine particles A having both an average major diameter and an average minor diameter of 3.5 μm was further added thereto.

### Example 9

A paste was prepared by the same method as in Example 2, except that the content of the metal nanowires recovered by the same method as in Example 1 was changed to 36% by mass, the content of the bisphenol A-type epoxy resin (YD014, manufactured by NIPPON STEEL & SUMITOMO METAL CORPORATION) was changed to 26.4% by mass, and the content of the microcapsule-type latent curing agent (NOVACURE 3941, manufactured by Asahi Kasei E-Materials Corporation) was changed to 17.6% by mass.

### Example 10

A paste was prepared by the same method as in Example 2, except that the type of the metal used in the metal filling step was changed to nickel.

### Example 11

The paste prepared in Example 2 was applied onto a Teflon (registered trademark)-coated stainless steel plate using an applicator, and the coating amount was adjusted so that the thickness after drying was 30 μm. Next, the paste was dried at 250° C. for 2 hours in a nitrogen atmosphere to prepare a sheet.

### Example 12

A sheet was prepared by the same method as in Example 11, except that the paste prepared in Example 4 was used.

### Comparative Example 1

A paste was prepared by the same method as in Example 2, except that metal nanowires prepared by a method not including the crushing step was used.

In addition, an SEM image (magnification: 2,000 times) of the metal nanowires produced in Comparative Example 1 is shown in FIG. 3.

### Comparative Example 2

A paste was prepared by the same method as in Example 2, except that the content of the metal nanowires recovered by the same method as in Example 1 was changed to 12% by mass, the content of the bisphenol A-type epoxy resin (YD014, manufactured by NIPPON STEEL & SUMITOMO METAL CORPORATION) was changed to 40% by mass, and the content of the microcapsule-type latent curing agent (NOVACURE 3941, manufactured by Asahi Kasei E-Materials Corporation) was changed to 28% by mass.

### [Evaluation]

### [Conductivity]

The paste prepared in each of Examples 1 to 10 and Comparative Examples 1 and 2 was applied onto a Cu plate (10 mm×10 mm×0.5 mm) with a squeegee using a metal mask (opening portion: 1×1 mm×0.2 mm), and a Cu plate (5 mm×5 mm×0.5 mm) was placed on the applied paste. For the sheets prepared in Examples 11 and 12, a laminate was produced in which a sheet cut into a size of 5×5 mm was sandwiched between the two Cu plates described above.

Next, using a bonding device (WP-100, manufactured by PROTEC MEMS Technology), the atmosphere in the device was replaced with a reducing gas (N2: 85%, formic acid: 15%) and then the Cu plate and the paste (sheet) were subjected to heating and pressure bonding under conditions of 250° C., 1 minute, and 5 MPa to produce a sample in which the Cu plate and the paste (sheet) were bonded to each other.

Next, using LORESTA GP manufactured by Dia Instruments Co., Ltd., a distance between measurement terminals (pins) was set to 3 mm, the measurement terminals were applied to the upper and lower copper plates, a pressing pressure (spring pressure) of the measurement terminals was set to 200 g, a connection resistance was measured, and the evaluation was performed according to the following standard. The results are shown in Table 1 below.

### <Evaluation Standard>

A: connection resistance was 120% or less with respect to the resistance of copper.
B: connection resistance was more than 120% and 150% or less with respect to the resistance of copper.
C: connection resistance was more than 150% with respect to the resistance of copper.

### [Bonding Strength]

A die shear strength was measured using a 4000 universal bond tester manufactured by Nordson Corporation for the sample used for measuring the connection resistance, and the evaluation was performed according to the following standard. The results are shown in Table 1 below.

### <Evaluation Standard>

A: 15 MPa or more
B: 10 MPa or more and less than 15 MPa
C: less than 10 MPa

### [Heat Dissipation Properties]

Thermal conductivity of the produced paste or sheet was measured by the following method, and evaluated according to the following standard. The results are shown in Table 1 below.

Specifically, the produced paste or sheet was installed on a flat surface side of an aluminum heat sink in a size of 20 mm×20 mm. In this case, after the paste was applied with a squeegee using a metal mask (opening portion: 20×20 mm×0.2 mm), the atmosphere in the device was replaced with a reducing gas using a reducing gas (N2: 85%, formic acid: 15%) using a normal temperature bonding device (WP-100, manufactured by PROTEC MEMS Technology), and then the paste was heated under a condition of 250° C. and 1 minute without pressure. The sheet was processed to a size of 20 mm×20 mm and then attached to a heat sink using thermal grease. After bonding the paste or the sheet to the heat sink, a power semiconductor TO-247 was bonded as a heat source using thermal grease.

Next, a temperature difference between the heat source and the heat sink plane was divided by the power consumption to calculate the thermal resistance, which was converted into the thermal conductivity.

### <Evaluation Standard>

A: 50 W/mK or more
B: 10 W/mK or more and less than 50 W/mK
C: less than 10 W/mK

TABLE 1

| | | Metal nanowires | | | | | | |
|---|---|---|---|---|---|---|---|---|
| | | | | | Specific | | Conductive | |
| | | | | | surface | Content | fine particles | |
| | Form of | Metal | Thickness | Length | area | % by | Metal | |
| | composition | type | nm | μm | m²/kg | mass | type | Shape |
| Example 1 | Paste | Cu | 60 | 20 | 7000 | 80 | — | — |
| Example 2 | Paste | Cu | 60 | 20 | 7000 | 68 | — | — |
| Example 3 | Paste | Cu | 60 | 5 | 7500 | 68 | — | — |
| Example 4 | Paste | Cu | 60 | 20 | 7000 | 56 | Cu | Sphere |
| Example 5 | Paste | Cu | 60 | 20 | 7000 | 56 | Cu | Flake |
| Example 6 | Paste | Cu | 60 | 20 | 7000 | 56 | Cu | Sphere |
| Example 7 | Paste | Cu | 60 | 20 | 7000 | 61.6 | Cu | Sphere |
| Example 8 | Paste | Cu | 60 | 20 | 7000 | 66.4 | Cu | Sphere |
| Example 9 | Paste | Cu | 60 | 20 | 7000 | 36 | — | — |
| Example 10 | Paste | Ni | 60 | 20 | 7000 | 68 | — | — |
| Example 11 | Sheet | Cu | 60 | 20 | 7000 | 68 | — | — |
| Example 12 | Sheet | Cu | 60 | 20 | 7000 | 56 | Cu | Sphere |
| Comparative | Paste | Cu | 60 | 20 | 50 | 68 | — | — |
| Example 1 | | | | | | | | |
| Comparative | Paste | Cu | 60 | 20 | 7000 | 12 | — | — |
| Example 2 | | | | | | | | |
| | Conductive fine particles | | | Resin | Curing | | | |
| | Average | Average | | material | agent | Evaluation | | |
| | major | minor | Content | Content | Content | | | Heat |
| | diameter | diameter | % by | % by | % by | | Bonding | dissipation |
| | μm | μm | mass | mass | mass | Conductivity | strength | properties |
| Example 1 | — | — | 0 | — | — | A | A | A |
| Example 2 | — | — | 0 | 7.2 | 4.8 | A | A | A |
| Example 3 | — | — | 0 | 7.2 | 4.8 | A | A | A |
| Example 4 | 3.5 | 3.5 | 12 | 7.2 | 4.8 | A | A | A |
| Example 5 | 3.1 | 0.5 | 12 | 7.2 | 4.8 | A | A | A |
| Example 6 | 25 | 17 | 12 | 7.2 | 4.8 | B | B | B |
| Example 7 | 3.5 | 3.5 | 6.4 | 7.2 | 4.8 | A | A | A |
| Example 8 | 3.5 | 3.5 | 1.6 | 7.2 | 4.8 | A | A | A |
| Example 9 | — | — | 0 | 26.4 | 17.6 | B | B | B |
| Example 10 | — | — | 0 | 7.2 | 4.8 | B | A | A |
| Example 11 | — | — | 0 | 7.2 | 4.8 | A | A | A |
| Example 12 | 3.5 | 3.5 | 12 | 7.2 | 4.8 | A | A | A |
| Comparative | — | — | 0 | 7.2 | 4.8 | B | C | B |
| Example 1 | | | | | | | | |
| Comparative | — | — | 0 | 40 | 28 | C | B | C |
| Example 2 | | | | | | | | |

From the results shown in Table 1, it was found that, in a case where metal nanowires having a specific surface area of less than 100 m²/kg were used, the bonding strength was deteriorated even in a case where the content thereof was 30% by mass or more (Comparative Example 1).

In addition, it was found that, even in a case where metal nanowires having a specific surface area of 100 to 50,000 m²/kg were used, the conductivity was deteriorated in a case where the content thereof was less than 30% by mass (Comparative Example 2).

On the other hand, it was found that, in a case where 30% by mass or more of metal nanowires having a specific surface area of 100 to 50,000 m²/kg was formulated, both the conductivity and the bonding strength were increased (Examples 1 to 12).

In addition, from the results of Examples 1 to 3 and 9, it was found that, in a case where the content of the conductive material contained in the composition according to the embodiment of the present invention was 50% to 90% by mass, the conductivity and the bonding strength were further increased, and the heat dissipation properties were also improved.

### EXPLANATION OF REFERENCES

1: valve metal substrate
2: pore (micropore)
3: anodized film
4: metal
5: isolated metal
10: metal nanowire

What is claimed is:

1. A composition for forming a conductive bonding material, comprising:
at least one conductive material selected from the group consisting of metal nanowires and a metal nanowire aggregate; and
a solvent,
wherein a specific surface area of the conductive material per unit mass is 100 to 50,000 m²/kg, and
a content of the conductive material is 30% by mass or more.

2. The composition for forming a conductive bonding material according to claim 1, further comprising:
conductive particles,
wherein an average major diameter of the conductive particles in a minimum enclosing ellipsoid is 0.01 μm or more and 50 μm or less, and is 1 to 10 times an average minor diameter of the conductive particles in the minimum enclosing ellipsoid.

3. The composition for forming a conductive bonding material according to claim 1, further comprising:
a resin material.

4. The composition for forming a conductive bonding material according to claim 1,
wherein an arithmetic mean value of lengths of the metal nanowires is 0.3 to 300 μm.

5. A conductive bonding material formed of the composition for forming a conductive bonding material according to claim 1.

6. A device comprising:
the conductive bonding material according to claim 5; and
a member provided on at least one surface of the conductive bonding material,
wherein the member is at least one selected from the group consisting of a semiconductor element, an electrode, and a wiring line.

7. A manufacturing method of a conductive bonding material, which is for manufacturing a conductive bonding material, comprising:
a step of supplying the composition for forming a conductive bonding material according to claim 1 onto a substrate.

8. The composition for forming a conductive bonding material according to claim 2, further comprising:
a resin material.

9. The composition for forming a conductive bonding material according to claim 2,
wherein an arithmetic mean value of lengths of the metal nanowires is 0.3 to 300 μm.

10. A conductive bonding material formed of the composition for forming a conductive bonding material according to claim 2.

11. A device comprising:
the conductive bonding material according to claim 10; and
a member provided on at least one surface of the conductive bonding material,
wherein the member is at least one selected from the group consisting of a semiconductor element, an electrode, and a wiring line.

12. A manufacturing method of a conductive bonding material, which is for manufacturing a conductive bonding material, comprising:
a step of supplying the composition for forming a conductive bonding material according to claim 2 onto a substrate.

13. The composition for forming a conductive bonding material according to claim 3,
wherein an arithmetic mean value of lengths of the metal nanowires is 0.3 to 300 μm.

14. A conductive bonding material formed of the composition for forming a conductive bonding material according to claim 3.

15. A device comprising:
the conductive bonding material according to claim 14; and
a member provided on at least one surface of the conductive bonding material,
wherein the member is at least one selected from the group consisting of a semiconductor element, an electrode, and a wiring line.

16. A manufacturing method of a conductive bonding material, which is for manufacturing a conductive bonding material, comprising:
a step of supplying the composition for forming a conductive bonding material according to claim 3 onto a substrate.

17. A conductive bonding material formed of the composition for forming a conductive bonding material according to claim 4.

18. A device comprising:
the conductive bonding material according to claim 17; and
a member provided on at least one surface of the conductive bonding material,
wherein the member is at least one selected from the group consisting of a semiconductor element, an electrode, and a wiring line.

19. A manufacturing method of a conductive bonding material, which is for manufacturing a conductive bonding material, comprising:
a step of supplying the composition for forming a conductive bonding material according to claim 4 onto a substrate.
